(19) United States
(12) Patent Application Publication
(10) Pub. No.: US 2020/0291048 A1
(43) Pub. Date: Sep. 17, 2020

(54) PRODUCTION PROCESS FOR PHOSPHOETHANOLAMINE

(71) Applicant: Marcos Vinicius De Almeida, Bauru (BR)

(72) Inventor: Marcos Vinicius De Almeida, Bauru (BR)

(73) Assignee: BIOLIFE SCIENTIFIC LLC, Orlando, FL (US)

(21) Appl. No.: 16/817,212

(22) Filed: Mar. 12, 2020

Related U.S. Application Data
(60) Provisional application No. 62/817,072, filed on Mar. 12, 2019.

(51) Int. Cl. C07F 9/09

(52) U.S. Cl. CPC C07F 9/091

(57) ABSTRACT

A method for the production of phosphoethanolamine is disclosed. Phosphoric acid and monoethanolamine are mixed at a sufficient ratio using a doser to form a solution. The solution is then esterified by heating the solution to about 200° C., followed by cooling the solution to 40° C. A sufficient amount of distilled water is added to the solution to produce the desired viscosity. Excess ethanol is then filtered from the solution via a suction element. The solution is then subjected to centrifugal action for up to four hours at 1800 RPM to separate the phosphoethanolamine until a moisture content below 20% is reached. The remainder is then air dried to further isolate the phosphoethanolamine.

### CROSS-REFERENCE TO RELATED APPLICATIONS

The present application claims priority to U.S. Provisional Application No. 62/817,072 filed on Mar. 12, 2019, entitled “PRODUCTION PROCESS FOR PHOSPHOETHANOLAMINE” the entire disclosure of which is incorporated by reference herein.

### TECHNICAL FIELD

The embodiments generally relate to a process for creating a chemical compound and, more specifically, relate to a process for creating the ethanolamine derivative phosphoethanolamine.

### BACKGROUND

Phosphoethanolamine is an ethanolamine derivative used to construct glycerophospholipids and sphingomyelin. Phosphoethanolamine is a precursor to phosphatidylcholine and phosphatidylethanolamine, which are both components of the cell membrane.

Cancer is a significant public health problem with the current treatments yielding limited success. Treatments having broad antitumor and potent inhibitor activity in a variety of tumor cells present the potential for widespread use for treating multiple types of cancer.

In recent years, research has been conducted with tumor cells in vitro to determine if phosphoethanolamine can be used as a cancer treatment. Though the exact mechanism has not been elucidated, preclinical results suggest that phosphoethanolamine is capable of suppressing tumor growth both in vitro and in vivo in mouse models. In further studies, phosphoethanolamine has been shown to increase the synthesis of acetylcholine and may be used to treat various neurodegenerative diseases including amyotrophic lateral sclerosis (ALS), Parkinson's disease, and Alzheimer's disease.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

Unless defined otherwise herein, all technical and scientific terms used herein have the same meaning as commonly understood by one of ordinary skill in the art to which this disclosure belongs. Various scientific dictionaries that include the terms included herein are well known and available to those in the art. Although any methods and materials similar or equivalent to those described herein find use in the practice or testing of the disclosure, some preferred methods and materials are described. Accordingly, the terms defined immediately below are more fully described by reference to the specification as a whole. It is to be understood that this disclosure is not limited to the particular methodology, protocols, and reagents described, as these may vary, depending upon the context in which they are used by those of skill in the art.

Numeric ranges are inclusive of the numbers defining the range. It is intended that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

A method for the production of phosphoethanolamine is disclosed. Phosphoric acid and monoethanolamine are mixed at a sufficient ratio using a doser to form a solution. The solution is then esterified by heating the solution to about 200° C., followed by cooling the solution to 40° C. A sufficient amount of distilled water is added to the solution to produce the desired viscosity, with the solution then placed into anhydrous ethanol solution for a period of between one day to more than two months for nucleation and crystals formation. The longer the period of anhydrous ethanol solution, the more symmetrical is the shape and the greater is the purity of the phosphoethanolamine crystals resulting from the process.

Excess ethanol is then filtered from the solution via a suction element. The solution is then subjected to centrifugal action for a period of between one to four hours at 1800 RPM to separate the phosphoethanolamine until a moisture content of between 1.5% to 20.0% is attained. The remainder is then air dried to further isolate the phosphoethanolamine.

In one aspect, a sufficient ratio of phosphoric acid and the monoethanolamine is one to two mols of phosphoric acid to one mol of monoethanolamine.

In one aspect, the sufficient ratio of phosphoric acid and monoethanolamine is agitated to accelerate the mixing step.

In one aspect, the mixing occurs in a glass-jacketed chemical reactor.

In one aspect, a gas scrubber is utilized to remove one or more byproducts, such as ammonia gas, during the production process.

In one aspect, a chiller is utilized to facilitate rapid cooling from 200° C. to 40° C.

In one aspect, the viscosity is measured via a Ford Cup or similar viscometer.

In one aspect, the phosphoethanolamine is vacuum packed for further processing or distribution.

In one aspect, a final product for consumption by a mammal is synthesized. The final product may contain one or more metals mixed with the phosphoethanolamine. The one or more metals are selected from the group consisting of: calcium, zinc, magnesium, and curcumin, among other metals or semi-metals. Additional compounding may include compounds of secondary metabolism derived from plants or from the metabolic pathway of shikimic acid.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates the structural formula of phosphoethanolamine, according to some embodiments; and

FIG. 2 illustrates a flowchart for a method for the production of Phosphoethanolamine, according to some embodiments.

### DETAILED DESCRIPTION

The embodiments provided herein are characterized by the description of different steps necessary for implementing the application in question such that it can be fully reproduced by adequate techniques, allowing the full characterization of the functionality of the process claimed herein. The disclosure is based on different steps described herein that express the best and preferred manner of carrying out the process. The steps may vary insofar as they do not depart from the spirit and scope of the present embodiments.

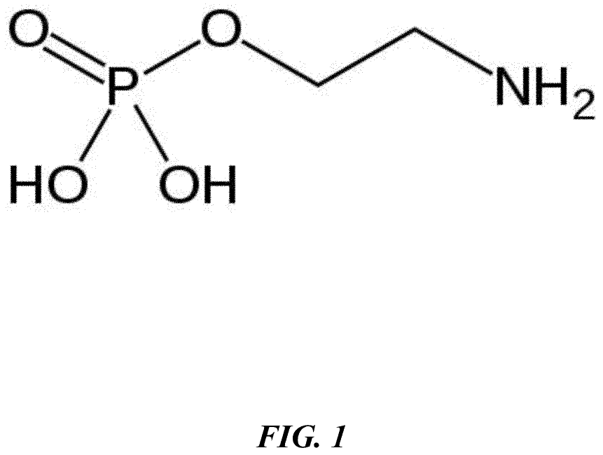

In general, the embodiments provided herein provide a method for the synthesis of 2-aminoethyl dihydrogen phosphate, which may also be referred to as phosphorylethanolamine or phosphoethanolamine as is known in the arts. Phosphoethanolamine, illustrated in FIG. 1, may be used as a foodstuff, supplement, as a cosmetic, as a medicament, and may be utilized by humans and/or animals.

One skilled in the arts will readily appreciate that the final product may be utilized as a medicinal agent, pharmaceutical, nutritional supplement or therapeutic agent in various mammals including humans.

### Phase 1—Reagent Mixing and Initial Reaction

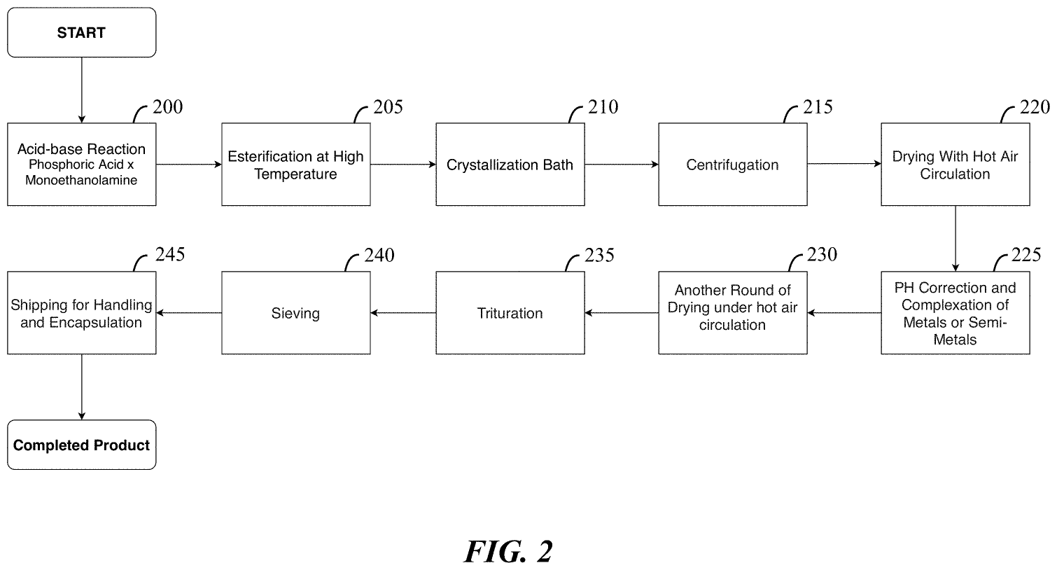

FIG. 2 illustrates a flowchart for the production process of phosphoethanolamine. In step 200, the phosphoethanolamine production process occurs by reacting, in specific proportions, phosphoric acid and monoethanolamine (MEA) to form an acid-base solution, or primary salt. Approximately 60 liters of monoethanolamine and 70 liters of phosphoric acid will be used for a 50 L batch, or a general mix ratio of one mol of monoethanolamine to between one and two mols of phosphoric acid. The initial reaction occurs in a glass-jacketed chemical reactor with heating capacity (required at a later stage) and, if possible, cooling (also necessary at a later stage). This reactor may be provided at an initial capacity of 50 L.

In some embodiments, the mixture may be agitated to accelerate the mixing process by 50%. Mixing may be performed by any means known in the arts.

During the reaction process, a doser, or acid flow controller, is required for the reaction to proceed in a controlled manner. In some embodiments, an acid metering pump is used. The reaction is an exothermic reaction which releases significant energy along with the by-product of ammonia gas. The presence of ammonia gas in sufficient concentration can be fatal to unprotected humans and is potentially explosive. Therefore, it is necessary to ensure that the mixing facility has proper ventilation and safety procedures, including ammonia concentration detection monitors and the use of appropriate respirators by the production staff. Ammonia gases can be removed by an industrial exhaust system and concentrated in a gas scrubber as dictated by local and federal regulations.

There is a separate doser used for each of the two primary reagents during the mixing process. On an industrial scale, the exact mix rate and ratio may vary to result in the optimal solution. The optimal variability in rate and ratio may be determined by the chemist or production personnel overseeing the procedure. The chemist monitors the process in real time to determine and judge critical variables, such as the amount of gases that are being expelled, the rate of temperature increase, the rate of color change, etc. These variables are specific to each container, the quantity being mixed, and environmental conditions such as relative humidity. There does not currently exist a definitive means for measuring these parameters using mechanical means; however, it is contemplated that mechanical methods may be developed that accurately track one or more of these parameters to introduce greater automation into the mixing process as well as to increase production quality.

In some embodiments, the reagents will be reacted in a reactor or other appropriate place, such as glass flasks, and under conditions of temperature and pressure, varied from the reaction system within a temperature range of −20° C. (negative) to maximum temperatures of 80° C. (positive). At molar concentrations of the phosphoric acid reagent of 1 mol, this acid will react with the monoethanolamine reagent, in the concentration of 1 mol, forming a yellowish homogenized solution known as the primary phosphoethanolamine salt.

At the end of the initial reaction process, there will be a natural temperature accumulation resulting from the reaction, which will aid the second phase, esterification, which will occur under constant heating.

### Phase 2—Heating of Solution (Esterification)

In step 205, the solution obtained in step 200 is then heated to 200 degrees Celsius, and any gas released in this process will be further concentrated in the above-mentioned gas scrubber. When the solution reaches the temperature of 200 degrees Celsius, the heating element is turned off, and the temperature is allowed to decrease to 40 degrees Celsius. The typical time required for ambient reduction in temperature is approximately four hours.

In some embodiments, the decrease in temperature can be accelerated by the aid of a cooling chiller coupled to the reactor, although such accelerated cooling is optional. Utilization of a chiller may reduce the cooling time to as low as 25 minutes.

In some embodiments, after homogenization, the solution, or primary salt obtained, may be heated to a temperature of 200° C. maximum temperature. After the heating process, an esterification process may take place, transforming the homogenized liquid into a thick, yellowish liquid with a characteristic odor.

### Phase 3—Addition of Distilled Water

After the esterified solution has cooled, deionized distilled water is then mixed into the solution in approximate proportions. The addition of distilled water into the solution is in the proportion necessary to obtain a certain viscosity of the solution. Viscosity is measured via the use of a Ford Cup, a standard instrument used for such purpose. Measurement standards for the use of this instrument relative to the production of phosphoethanolamine do not exist. However, through personal knowledge and experience of the chemist, it is possible to judge the ideal level of viscosity through visual inspection while stirring the liquid solution. Generally, 60 to 70% of distilled water is required to mix into the solution.

Once the desired level of viscosity is obtained, the solution is placed in a stainless-steel tank, and anhydrous ethanol is added to the solution. At this point in the process, the active principle will concentrate enough to form the clusters and the respective crystalline reticles of the molecule.

In some embodiments, the crystallization process (step 210) consists of mixing the resulting thick and esterified liquid and diluting it in water, keeping it homogenized under constant agitation with the aid of a mechanical stirrer or another method such as reflux or agitation with the aid of inert gas such as nitrogen or argon, at room temperature of 20° C. After complete solubilization is achieved, the resultant liquid will be placed into solvent solution to promote crystallization, with the result being phosphoethanolamine crystals. The organic solvent used is anhydrous ethanol, in the ratio of 8 liters of ethanol for each liter of liquid obtained in step of esterification described hereinabove. Other organic solvents such as methanol, acetone, acetonitrile, n-hexane, n-pentane, 2 methyl sulfoxide and chloroform may be used in addition to anhydrous ethanol.

The time required for the formation of the crystal is up to two months after the start of the process, with time duration correlated to greater crystal symmetry and purity. After the crystallization period, the crystals (phosphoethanolamine salt) are separated from the waste product through the process of separation in sieves, or centrifugation (step 215) with the aid of filtering material, or evaporation, or another method of separating solid-liquid phases.

### Phase 4—Suction

After 24 hours of the above process, the excess ethanol will be pumped with the aid of a suction pump for disposal. This alcohol residue will carry with it residues of phosphoric acid and other by-products of the chemical reaction. If necessary, acid-base reactions can also be used to remove excess acid in the reaction without reaching the maximum pH level of 3.0, the violation of which can adversely alter the complexing capacity of the molecule and phosphoethanolamine.

With the aid of appropriate blades (e.g., stainless steel), the active principle will be sent along with other residues to the centrifugation phase.

### Phase 5—Centrifuge and Forced Air-Drying

The active ingredient (phosphoethanolamine) is put into an industrial centrifuge duly adapted with a 180-mesh screen, or by appropriate tissue bags. Centrifugation is then applied for approximately 30 minutes at a rotation speed of 1800 rotations-per-minute (RPM).

During the centrifugation process, significant amounts of reaction residues such as alcohol, water, phosphoric acid, and other by-products will be released, which should be collected in containers. About 35% by volume of waste is released from the initial amount.

At the end of the centrifugation and air-drying process (step 220), the moisture content of the ingredient is between about 8% and 15%, and the drying process should be finished in a forced drying chamber or oven. In this process, the warm and circulating air in the room is expelled out to the environment with the aid of an exhaust system. Released gases are still rich in ethanol and are explosive if not properly disposed of and performed in a high exhaust environment.

The final product is a salt that should be packed in appropriately sized stainless-steel trays for better storage in the heated oven apparatus for continued drying. At this time, the salt can be distributed to the ideal capacity of the available trays. The more salt in any given tray, the longer the required drying time in the oven. More space and greater tray availability results in less salt density per tray and allows it to dry faster. The final targeted humidity is around 2%.

In some embodiments, After this step of separating the crystal from the solvents used, the crystals obtained will be dried under dry air at a temperature up to 90° C.; until they have a moisture content of 1.5%. After these crystals are dried, the first stage of synthesis of 2-aminoethyl dihydrogen phosphate or phosphoethanolamine will be complete. To obtain purity up to 99.99%, the crystallization processes described in steps (1.C and 1.D) must be repeated until the desired purity is reached. The phosphoethanolamine salt obtained may be chemically complexed with some products such as metals or semi-metals from the periodic table, depending upon the desired end use as a food supplement, medicine or cosmetic intended for human and/or veterinary consumption.

Complexation with Metals, Semi-Metals, and Non-Organic Mineral Salts

For the process of complexing metals, semi-metals and mineral salts (step 225), the phosphoethanolamine molecule, the crystals or salt of phosphoethanolamine obtained in step 1, will be diluted in distilled water and will have its pH checked with the aid of a meter or other appropriate method of pH measurement (for example, universal indicator, acid-base titration, or litmus paper). After checking the pH of the aqueous solution of phosphoethanolamine already completely solubilized in water, the pH will be raised to a pH of 3.5 by the introduction of metallic bases made available in the form of carbonates, which may be calcium, zinc, magnesium, copper, strontium, boron, molybdenum, iron, chromium, iodine, manganese and/or selenium. The amounts of each of these basic salts used can vary in the specific combinations and concentrations of each of the elements mentioned up to the maximum point of phosphoethanolamine complexing capacity that comprises the pH value of 7.2. After this specific pH value (7.2) is reached, any substance that will be mixed with the solution will no longer form a complex, but instead a simple mixture, remaining physically and chemically decoupled from the primary phosphoethanolamine molecule. After homogenization, this solution will be dried in dry air ovens until the desired humidity for the handling process is obtained, whether in capsules, compression, gel, cultured adhesives, food mix, cosmetic mix, and other forms of administration such as injections or suppositories.

The phosphoethanolamine crystals can also be mixed and homogenized with other non-metallic components such as essential and non-essential amino acids for humans and other animals, vitamins, essential oils, plant extracts, or other active ingredients such as medicines of various kinds. Additional compounding may include compounds of secondary metabolism derived from plants or from the metabolic pathway of shikimic acid. In some embodiments, and in step 230, a second drying stage is performed using circulated hot air as described in step 220. In step 235.

### Phase 6—Vacuum Packing

In the vacuum packing process, the salt is vacuum packed, weighed, and a sample is sent for qualitative and quantitative chemical analysis to confirm purity and to test for possible contaminants.

### Phase 7—Final Product Synthesis

The mixing with metals or other products of nutritional interest can be done as required to meet desired final product specifications. In some embodiments, titration (step 235) is implemented. In this process, the phosphoethanolamine salt may be complexed by blending with desired metals such as calcium, zinc, magnesium or other products, such as curcumin. For this phase, the same crystallization vessels may be used, but mixers, rotary grinders (such as industrial stainless-steel blenders) and industrial sieves (including 40, 100, 150 and 209 mesh) packaged on vibrating platforms will also be used (step 240).

In step 245, the final product is packaged for shipping, handling, and/or encapsulation. At the end of the final product synthesis process, the phosphoethanolamine salt has already been transformed into a pharmaceutical input or nutritional input and can be sent to desired end-product manipulation such as encapsulation, compression, further formulation, or other processes.

The final preparation of phosphoethanolamine may be formulated or otherwise prepared and may be utilized by a human or animal to treat various ailments including diseases such as various cancers, neurodegenerative diseases, and cellular disorders and metabolites.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A method for the production of phosphoethanolamine comprising the steps of:
mixing phosphoric acid and monoethanolamine at a sufficient ratio using a doser to form a solution;
esterifying the solution by heating the solution to about 200° C.;
cooling the solution to 40° C.;
adding a sufficient amount of distilled water to the solution to produce the desired viscosity;
filtering excess ethanol from the solution via a suction element;
subjecting the solution to centrifugal action for up to four hours at 1800 RPM to separate the phosphoethanolamine from the solution until a moisture content of below 20% is reached; and
air drying the phosphoethanolamine.

2. The method of claim 1, wherein a sufficient ratio of phosphoric acid and the monoethanolamine is 6:7.

3. The method of claim 1, wherein the sufficient ratio of phosphoric acid and monoethanolamine is agitated to accelerate mixing.

4. The method of claim 1, wherein the mixing occurs in a glass-jacketed chemical reactor.

5. The method of claim 1, further comprising a gas scrubber to remove one or more byproducts during the production process.

6. The method of claim 1, further comprising a chiller to facilitate rapid cooling from 200° C. to 40° C.

7. The method of claim 1, wherein viscosity is measured via a Ford Cup.

8. The method of claim 1, further comprising the step of vacuum packing the phosphoethanolamine.

9. The method of claim 1, further comprising the step of synthesizing a final product for consumption by a mammal by mixing phosphoethanolamine with various metals, semi-metals and/or metabolic compounds.

10. The method of claim 9, further comprising the step of mixing one or more metals into the final product.

11. The method of claim 10, wherein the one or more metals are selected from the group consisting of: calcium, zinc, magnesium, and curcumin.

12. A method for the production of phosphoethanolamine comprising the steps of:
providing phosphoric acid and monoethanolamine to a glass-jacketed chemical reactor;
mixing and agitating, phosphoric acid and monoethanolamine at a sufficient ratio using a doser to form a solution;
esterifying the solution by heating the solution to about 200° C.;
cooling the solution to about 40° C.;
adding a sufficient amount of distilled water to the solution to produce the desired viscosity;
filtering excess ethanol from the solution via a suction element;
centrifuging the solution for 30 minutes at 1800 RPM to separate the phosphoethanolamine from the solution until a moisture content of about 8% to 15% is reached; and
air drying the phosphoethanolamine.

13. The method of claim 12, wherein a sufficient ratio of phosphoric acid and the monoethanolamine is 6:7.

14. The method of claim 13, wherein viscosity is measured via a Ford Cup.

15. The method of claim 14, further comprising the step of vacuum packing the phosphoethanolamine.

16. The method of claim 15, further comprising the step of synthesizing a final product for consumption by a mammal by mixing phosphoethanolamine with various metals, semi-metals and/or metabolic compounds.

17. The method of claim 16, further comprising the step of adding one or more of the following: one or more metals, one or more semi-metals, and one or more non-organic mineral salts.

18. The method of claim 17, wherein the one or more metals are selected from the group consisting of: calcium, zinc, magnesium, and curcumin.

19. The method of claim 18, wherein the phosphoethanolamine is prepared as at least one of the following:
a foodstuff;
a supplement;
a medicament;
an injectable;
a suppository;
a capsule;
a compression; and
a gel or similar nanostructured topical application.

20. A method for the production of phosphoethanolamine comprising the steps of:
providing phosphoric acid and monoethanolamine to a glass-jacketed chemical reactor;
mixing and agitating, phosphoric acid and monoethanolamine at a sufficient ratio using a doser to form a solution;
esterifying the solution by heating the solution to about 200° C.;
cooling the solution to about 40° C.;
adding a sufficient amount of distilled water to the solution to produce the desired viscosity;
filtering excess ethanol from the solution via a suction element;
subjecting the solution to centrifugal action for up to four hours at 1800 RPM to separate the phosphoethanolamine from the solution until a moisture content below 20% is reached;
air drying the phosphoethanolamine;
adding at least one of the following: one or more metals, one or more semi-metals, and one or more non-organic mineral salts; and
preparing the phosphoethanolamine as a medicament for the treatment of a disease.
